(19) United States
(12) Patent Application Publication
(10) Pub. No.: US 2017/0052310 A1
(43) Pub. Date: Feb. 23, 2017

(54) LIGHT-EMITTING SIGNBOARD

(71) Applicant: Ledyoung Technology Corporation, Taoyuan City (TW)

(72) Inventor: Yen-Chou HSU, Taoyuan City (TW)

(21) Appl. No.: 14/827,885

(22) Filed: Aug. 17, 2015

(51) Int. Cl. F21V 8/00

(52) U.S. Cl. CPC G02B 6/0061; G02B 6/0051; G02B 6/0068; G02B 6/0073

(57) ABSTRACT

A light-emitting signboard includes a light guide plate having a light-emitting region on a front surface thereof and a plurality of light diffusing portions located in the light-emitting region and configured to refract and diffuse light, and a light source configured to emit light into the light guide plate through one peripheral edge thereof. The total surface area of the light diffusing portions is larger than or equal to one half of the surface area of the light-emitting region, and, the density of the light-emitting regions in the light diffusing portion at the area adjacent to the light source is smaller than the density of the light-emitting regions at the area far from the light source.

### BACKGROUND OF THE INVENTION

1. Field of the Invention

The present invention relates to signboard technology and more particularly, to a light-emitting signboard, which has light diffusing portions arranged in a light-emitting region of a light guide plate thereof for producing more uniform light with less power consumption.

2. Description of the Related Art

Light-emitting signboards are widely used for advertisement, road sign and escape indication applications. Regular light-emitting signboards commonly comprise a light guide plate, a LED-based light source configured to emit light into the light guide plate, and light diffusing components mounted in the light guide plate and configured to refract and diffuse light toward the outside of the light guide plate.

Generally, increasing the number of the light diffusing components in the light guide plate enhances light diffusing and lowers LED power consumption. However, when a large number of light diffusing components is arranged in the light guide plate, the area adjacent to the LED-based light source will be more bright than the area far from the LED-based light source, resulting in uneven brightness of light. In order to avoid this problem, the current method is to reduce the number of the light diffusing components in the light guide plate and to increase the brightness of the LEDs of the LED-based light source so that the light guide plate can produce more uniform light. However, this method relatively increases the power consumption of the LEDs.

### SUMMARY OF THE INVENTION

The present invention has been accomplished under the circumstances in view. It is therefore the main object of the present invention to provide a light-emitting signboard, which effectively produces more uniform light with minimized power consumption.

To achieve this and other objects of the present invention, a light-emitting signboard comprises a light guide plate having a light-emitting region on a front surface thereof and a plurality of light diffusing portions located in the light-emitting region and configured to refract and diffuse light, and at least one light source configured to emit light into the light guide plate through one peripheral edge thereof, wherein the total surface area of the light diffusing portions is larger than or equal to one half of the surface area of the light-emitting region, and, the density of the light-emitting regions in the light diffusing portion at the area adjacent to the light source is smaller than the density of the light-emitting regions at the area far from the light source. Thus, the light-emitting region can produce more uniform light.

Further, the light diffusing portions can be inwardly curved concave surface portions or outwardly curved convex surface portions of the light-emitting region.

Preferably, each light source comprises a plurality of light-emitting diodes, and, multiple light sources are arranged at different peripheral edges of said light guide plate.

### BRIEF DESCRIPTION OF THE DRAWINGS

FIG. 1 is a schematic drawing illustrating the outer appearance of a light-emitting signboard in accordance with the present invention.

FIG. 2 corresponds to FIG. 1, illustrating the arrangement of the light diffusing portions in the light-emitting region of the light guide plate.

FIG. 3 is a sectional view, illustrating one design of the light guide plate in accordance with the present invention.

FIG. 4 is a sectional view, illustrating an alternate form of the light diffusing portions of the light guide plate in accordance with the present invention.

FIG. 5 is a schematic drawing illustrating two light sources arranged at two different sides relative to the light guide plate in accordance with the present invention.

### DETAILED DESCRIPTION OF THE PREFERRED EMBODIMENT

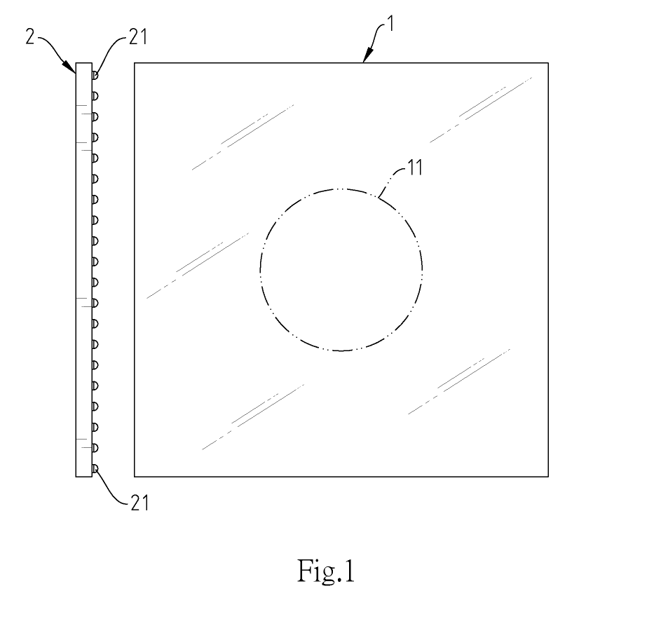

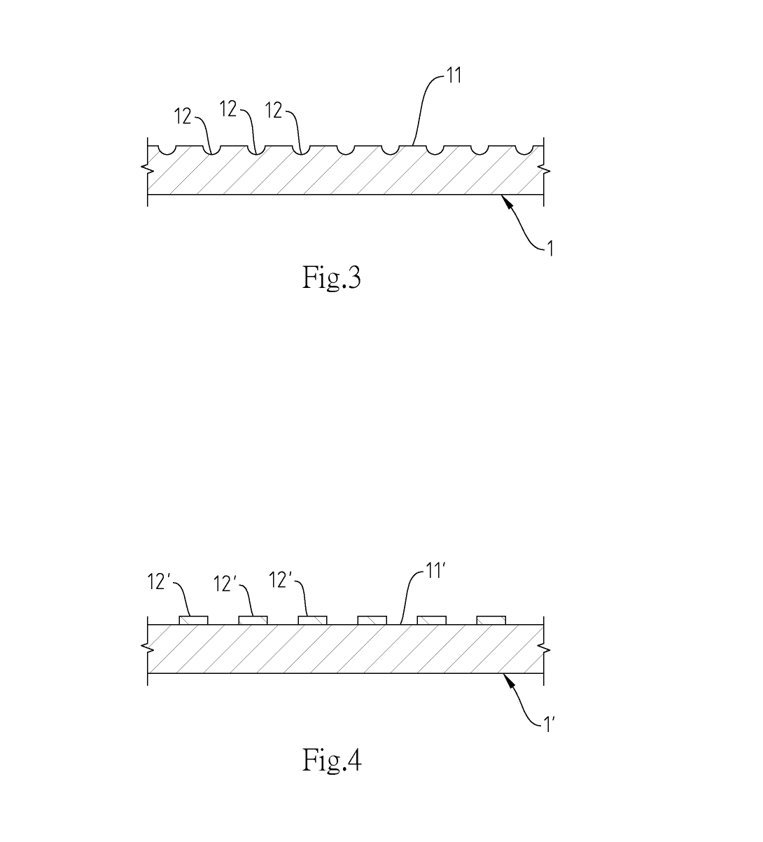

Referring to FIGS. 1-3, a light-emitting signboard in accordance with the present invention is shown. The light-emitting signboard comprises a light guide plate 1, and a light source 2 disposed at one lateral side of the light guide plate 1.

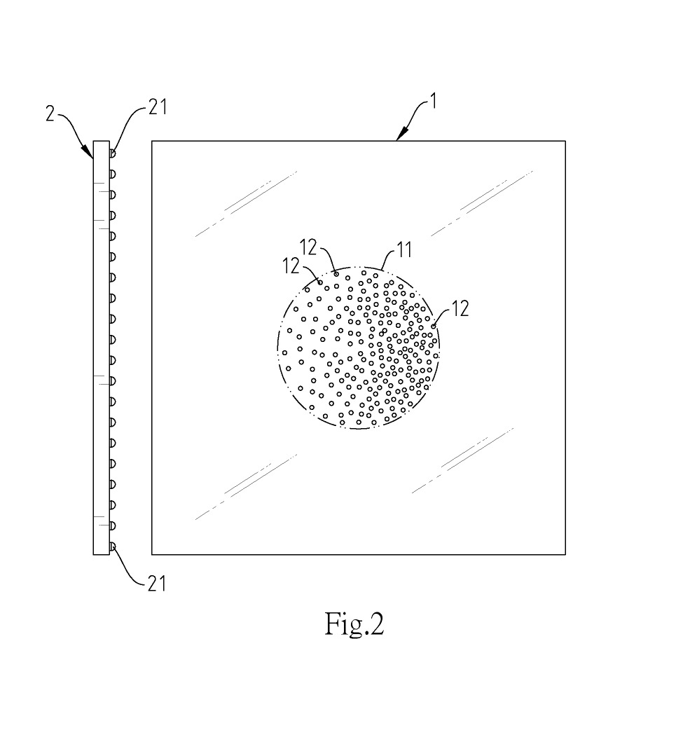

The light guide plate 1 comprises a light-emitting region 11 on a front surface thereof, and a plurality of light diffusing portions 12 disposed in the light-emitting region 11 and configured to refract and diffuse light. The light diffusing portions 12 have the same size and shape. In this embodiment, the light diffusing portions 12 are inwardly curved concave surface portions of the light-emitting region 11 of the light guide plate 1. Further, the total surface area of these light diffusing portions 12 is larger than or equal to one half of the surface area of the light-emitting region 11. In one example of the present invention, the surface area of the light-emitting region 11 is 100 cm²; the surface area of each light diffusing portion 12 is 0.03 mm²; the number of the light diffusing portion 12 is 1,700,000 pcs; the total surface area of the light diffusing portions 12 is 51 cm², i.e., larger than one half of the surface area of the light-emitting region 11. Further, as shown in FIG. 2, the density of the light diffusing portions 12 at a proximity side of the light-emitting region 11 adjacent to the light source 2 is smaller than that at an opposite distal side of the light-emitting region 11 far from the light source 2. For the purpose of illustration, the light diffusing portions 12 are shown in an enlarged scale. The illustration is not intended to limit the design of the size of the light diffusing portions 12.

The light source 2 comprises a plurality of light-emitting diodes 21 adapted for emitting light into the light guide plate 1 through its one lateral edge.

Subject to the design that the total surface area of the light diffusing portions 12 is larger than or equal to one half of the surface area of the light-emitting region 11, the light diffusing portions 12 can refract and diffuse the major part of incident light, enabling incident light to be evenly distributed through the overall surface area of the light-emitting region 11, and thus, sufficient brightness of light can be emitted out of the light-emitting region 11. Further, subject to the design that the density of the light diffusing portions 12 in the light-emitting region 11 at the side adjacent to the light source 2 is smaller than that at the side far from the light source 2, more light energy can pass through the proximity side of the light-emitting region 11 toward the distal side thereof and than refracted and diffused out of light-emitting region 11 toward the outside by light diffusing portions 12 at the distal side of the light-emitting region 11, and thus, the light-emitting region 11 can produce more uniform light.

Referring to FIG. 4, in an alternate form of the present invention, the light diffusing portions 12′ in the light-emitting region 11′ of the light guide plate 1′ are outwardly curved convex surface portions of the light-emitting region 11.

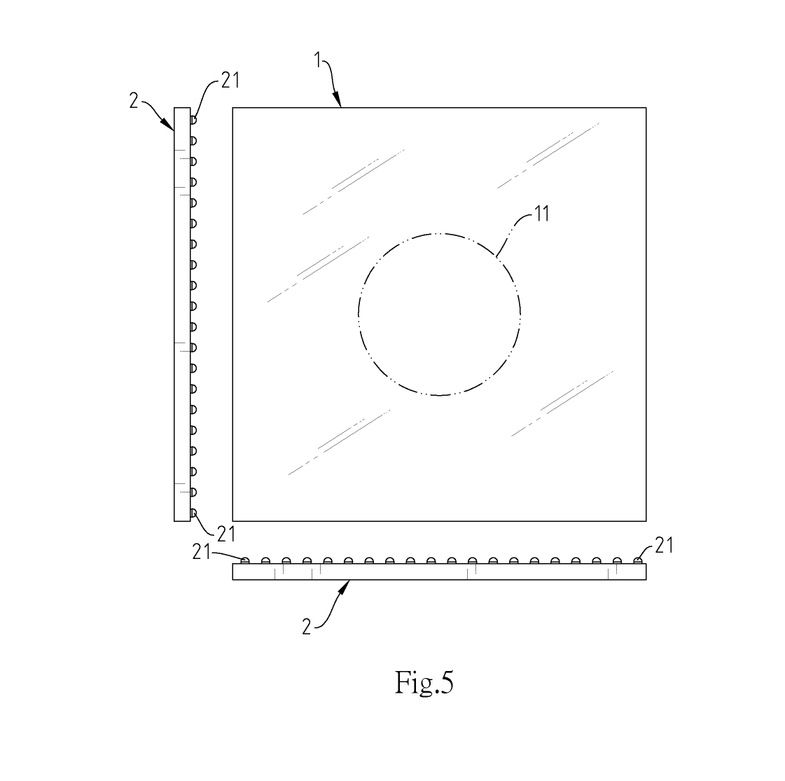

Referring to FIG. 5, in another alternate form of the present invention, multiple light sources 2 are arranged at different peripheral edges of the light guide plate 1.

What the invention claimed is:

1. A light-emitting signboard, comprising a light guide plate and at least one light source configured to emit light into said light guide plate, wherein:
said light guide plate comprises a light-emitting region on a front surface thereof, and a plurality of light diffusing portions located in said light-emitting region and configured to refract and diffuse light, the total surface area of said light diffusing portions being larger than or equal to one half of the surface area of said light-emitting region, the density of said light-emitting regions in said light diffusing portion at the area adjacent to said at least one light source is smaller than the density of said light-emitting regions in said light diffusing portion at the area far from said at least one light source.

2. The light-emitting signboard as claimed in claim 1, wherein said light diffusing portions are inwardly curved concave surface portions of said light-emitting region.

3. The light-emitting signboard as claimed in claim 1, wherein said light diffusing portions are outwardly curved convex surface portions of said light-emitting region.

4. The light-emitting signboard as claimed in claim 1, wherein each said light source comprises a plurality of light-emitting diodes.

5. The light-emitting signboard as claimed in claim 1, wherein a plurality of said light sources are arranged at different peripheral edges of said light guide plate.

6. The light-emitting signboard as claimed in claim 1, wherein said light diffusing portions have the same surface area and shape.
